(19) United States
(12) Patent Application Publication
(10) Pub. No.: US 2005/0104863 A1
(43) Pub. Date: May 19, 2005

(54) Computer kiosk

(76) Inventor: William S. Kroll, Houston, TX (US)

Correspondence Address: Wisner & Associates;Suite 400, 1177 West Loop South, Houston, TX, 77027-9012, US

(21) Appl. No.: 10/715,902

(22) Filed: Nov. 17, 2003

(51) Int. Cl. G09G 5/00

(52) U.S. Cl. 345/173

(57) ABSTRACT

An integrated computer and computer kiosk in which the component parts of the computer are mounted directly to the component parts of the kiosk, thereby minimizing assembly costs and weight. The kiosk includes a base, a back plate, one or more computer components mounted to and in direct contact with the back plate to facilitate heat transfer to the back plate and base so as to dissipate heat. A touchscreen is also mounted to the back plate in a manner that facilitates the transfer of heat from the touchscreen to the back plate with the one or more computer components positioned between the touchscreen and the back plate. A housing is mounted to the base plate to enclose the computer components.

### BACKGROUND OF THE INVENTION

The present invention relates to a touchscreen computer kiosk. In more detail, the present invention relates to a kiosk in which the individual components of the touchscreen computer and stand are integrated into a kiosk that is light in weight, comprised of a minimum number of components so as to decrease cost, and yet durable enough for everyday service in such public places as shopping malls, railroad and bus stations, airports, and government buildings.

Known kiosks, regardless of whether they are wall mounted or free standing, are constructed in a manner in which they are little more than housings in which finished computer components are supported, encased, or mounted. They include, for instance, a shelf on which the case of a conventional desktop computer is mounted and a window through which the display screen is viewed and/or accessed (if the screen is a touchscreen). Such kiosks are characterized by a number of disadvantages and limitations, including the relatively large size required to house the computer components and in the case of wall-mounted kiosks, the heavy weight of kiosks of such size. Many such kiosks are also characterized by difficulties in accessing the computer components contained therein for service.

It is, therefore, an object of the present invention to provide a computer kiosk that overcomes these disadvantages and limitations by providing a kiosk in which the computer components (rather than a finished computer) are integrated with the support and housing into a unitary kiosk that is light in weight, comprised of a minimum number of components, and is durable enough for everyday service in public places and other demanding applications.

Another object of the present invention is to provide a touchscreen computer kiosk that requires minimal assembly, thereby decreasing manufacturing costs and facilitating the servicing of the computer components housed in the kiosk.

Another object of the present invention is to provide a touchscreen computer kiosk that is light enough in weight to allow enough flexibility that the kiosk can be utilized in a wide variety of wall and other mounting applications.

Another object of the present invention is to provide a touchscreen computer kiosk that is adapted for specialty applications such as in environments in which the kiosk may be exposed to water or ambient moisture, vibration, or other external stresses that would tend to shorten the service life of computers housed in previously known kiosks.

Other objects, and the advantages, of the touchscreen computer kiosk of the present invention will be made clear to those skilled in the art by the following description of a presently preferred embodiment thereof.

### SUMMARY OF THE INVENTION

These objects are achieved by providing a touchscreen computer kiosk comprising a stand, a back plate mounted to the stand, and one or more computer components selected from the group consisting of a motherboard, hard drive, or power supply, the one or more computer components being mounted directly to the back plate, which functions as a sink for dissipating heat produced by the computer components. A touchscreen is mounted to the back plate with the one or more computer components positioned between the touchscreen and the back plate. A housing is mounted to the back plate for enclosing the computer components and the touchscreen. In one particularly preferred embodiment, the housing is pivotally mounted to the back plate so that the housing can be opened for easy access to the components housed therein.

### BRIEF DESCRIPTION OF THE DRAWINGS

FIG. 1 is an exploded perspective view of a preferred embodiment of a touchscreen computer kiosk constructed in accordance with the teachings of the present invention.

### DETAILED DESCRIPTION OF THE PREFERRED EMBODIMENT

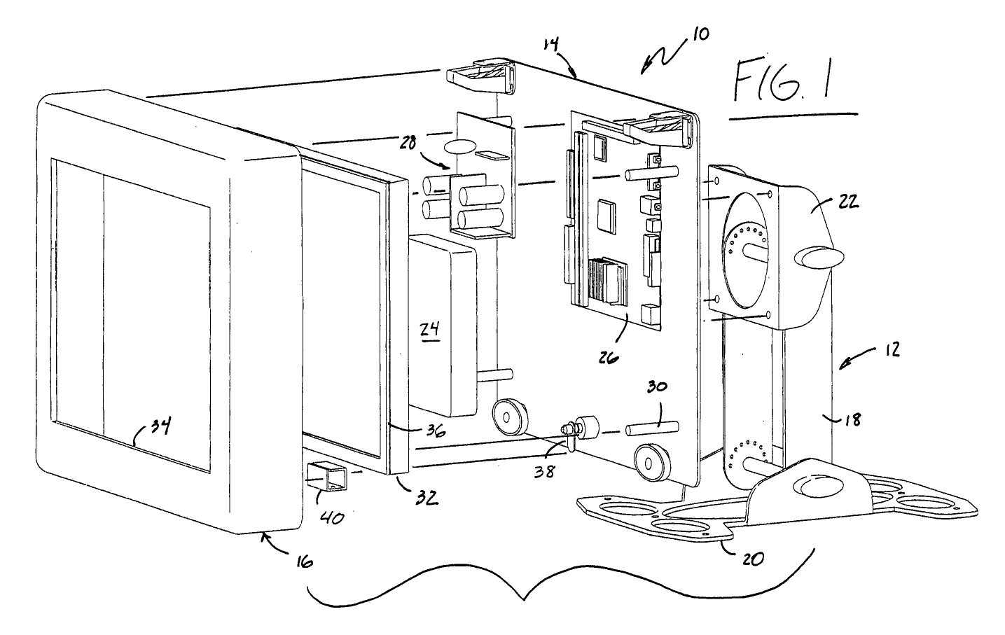

Referring to FIG. 1, a preferred embodiment of the computer kiosk, indicated generally at reference numeral 10, is shown. Computer kiosk 10 is comprised of a stand 12, back plate 14, and housing 16. The stand 12 is similar to a type known in the art in which a standard 18 is pivotally mounted at one end to a base 20 and a mounting bracket 22 is pivotally mounted to the other end of standard 18.

Back plate 14 is provided with a plurality of holes (not shown) for receiving bolts or other fasteners for securing the back plate 14 to the mounting bracket 22 of stand 12. Back plate 14 is preferably comprised of a durable material such as aluminum that is characterized by its light weight and its ability to transfer heat from the computer components housed in kiosk 10 as described below. To facilitate heat transfer, and the subsequent dissipation of heat by back plate 14, back plate 14 may be provided with a plurality of holes, fins, or other structure for increasing the passage of air through the back plate and/or increasing the surface area of back plate 14 so as to increase the rate of transfer of heat into the ambient air surrounding back plate 14. The close contact between back plate 14 and the mounting bracket 22 of stand 14 also facilitates heat transfer from the back plate 14 to stand 12 such that both back plate 14 and stand 12 function as heat sinks for the heat produced by the computer components.

The computer components of the touchscreen computer include one or more of a hard drive 24, motherboard 26, and power supply 28, each of which are mounted to back plate 14 in direct contact with the back plate 14, thereby facilitating the transfer of heat from each such component to back plate 14 for dissipating the heat in the manner described above. Any of a variety of fasteners, bracket, and other structure known in the art can be utilized for this purpose, the manner in which the computer components are attached to back plate 14 being unimportant so long as the components contact back plate 14 to facilitate heat transfer. The motherboard 26 is of a type known in the art that does not require a fan for air circulation; similarly, the power supply 28 is of a type known in the art that is open, e.g., is not enclosed in a case, and likewise lacks a fan for air circulation. Power supply 28 is mounted to back plate 14 in an orientation that facilitates the movement of air through the power supply 28 in the same direction as the air moving through the space between housing 16 and back plate 14 so that air movement that results from the heating of the air inside housing 16 is actually facilitated by the heating of the air in and around power supply 28.

As used herein, the phrase “mounted in direct contact with back plate 14” is not intended to be restricted to an arrangement in which the computer component actually contacts the back plate 14. Instead, this phrase is intended to describe the functional relationship between computer component and back plate 14 where the function, in addition to the obvious function of supporting the computer component, is the transfer of heat. For instance, if the computer component is supported from back plate 14, even indirectly and/or by intervening structure, the computer component is still considered to be mounted in direct contact with back plate 14 if the physical relationship between these structural components allows for direct transfer of heat from the computer component to back plate 14. To further illustrate this structural relationship, in a second embodiment (not shown), the capacitors of the power supply 28 are mounted to a printed circuit board (so as to spread them apart) and the printed circuit board is mounted to back plate 14 on standoffs of the type described for supporting the LCD touchscreen 32 as described in the following paragraph.

In a third embodiment of the present invention, the power supply 28 is not mounted to back plate 14 (it is for this reason that reference is made herein to “one or more computer components” being mounted to back plate 14). Instead, power supply 28 is replaced with an external 110 volt-to-12 volt converter and a cable simply distributes 12 volt power to the other computer components mounted to back plate 14.

Referring again to FIG. 1, plurality of standoffs 30 are mounted to back plate 14 for supporting an LCD touchscreen 32 of a type known in the art. Standoffs 30 are preferably comprised of a composite material that facilitates heat transfer through the standoffs 30 to back plate 14 such that this arrangement of touchscreen 32 and back plate 14 is also intended to fall within the scope of the definition of the phrase “mounted in direct contact with back plate 14” as used herein because of the transfer of heat from touchscreen 32 to back plate 14 through standoffs 30. Those skilled in the art who have the benefit of this disclosure will recognize that a commercially available heat transfer paste may be utilized in the mounting of touchscreen 32, or any of the other computer components 24, 26, 28, to back plate 14. The standoffs are fastened to back plate 14 and touchscreen 32 using any of several known fasteners and/or mounting brackets. Those skilled in the art will also recognize that in the preferred embodiment shown in FIG. 1, the computer components that generate the most heat, namely, the hard drive 24, mother board 26, and power supply 28 are mounted closer to back plate 14 than touchscreen 32 so as to facilitate the transfer of heat to back plate 14 and the subsequent dissipation of that heat such that one or more of the components 24, 26, 28 is mounted between touchscreen 32 and back plate 14.

Housing 16 is likewise mounted to back plate 14, preferably by hinges such as are shown at reference numeral 34, for opening and closing over the touchscreen 32. Housing 32 is provided with an open window 34 through which the touchscreen 32 is accessed during the use of the integrated computer and kiosk assembly of the present invention. To provide additional resistance to the intrusion of environmental stimuli such as moisture, a gasket 36 is applied to the front-facing surface of touchscreen 32 that is compressed by the inside surface of housing 16 when housing 16 is closed over touchscreen 32. Those skilled in the art who have the benefit of this disclosure will also recognize that gasket 36 can be mounted on the inside surface of housing 16 to bear against the front face of touchscreen 32. A latch, or cam lock, 38 is provided on back plate 14 for contacting a strike plate 40 mounted on housing 16 when turned for securing the housing 16 in the closed position and then unlocking housing 16 for access to the computer components 24, 26, 28, or touchscreen 32, enclosed therein.

Those skilled in the art who have the benefit of this disclosure will recognize that certain changes can be made to the component parts of the computer kiosk of the present invention without changing the manner in which those parts function to achieve their intended result. For instance, housing 16 can be mounted to back plate 14 on bushings with, for instance, quarter-turn quick release locking screws rather than hinges. In another such variation, the housing 16 is provided with a plurality of cut-outs and/or air holes, or a vent covered by mesh screening, or is itself comprised of perforated metal or similar material, to facilitate the loss of heat from within housing 16 to the ambient air. All such changes, and others which will no doubt be made clear to those skilled in the art by this description of the preferred embodiment, are intended to fall within the scope of the following, non-limiting claims.

1. An integrated computer and kiosk comprising:
a base;
a back plate mounted to said base;
one or more computer components selected from the group consisting of a motherboard, hard drive, or power supply, said one or more computer components being mounted in direct contact with said back plate, said back plate functioning as a sink for dissipating heat produced by said computer components;
a touchscreen mounted to said back plate with said one or more computer components between said touchscreen and said back plate; and
a housing mounted to said back plate for enclosing said computer components and said touchscreen.

2. The integrated kiosk of claim 1 wherein said housing is mounted to said back plate on hinges.

3. The integrated kiosk of claim 1 wherein said touchscreen is mounted to said back plate on a plurality of standoffs, each said standoff being comprised of a material for facilitating the transfer of heat from said back plate to said touchscreen.

4. The integrated kiosk of claim 1 additionally comprising a gasket for sealing between said touchscreen and said housing.
